(19) United States
(12) Patent Application Publication
(10) Pub. No.: US 2002/0138264 A1
(43) Pub. Date: Sep. 26, 2002

(54) Apparatus to convey depth information in graphical images and method therefor

(75) Inventors: Janani Janakiraman, Austin, TX (US); Rabindranath Dutta, Austin, TX (US)

Correspondence Address: Barry S. Newberger, 100 Congress Avenue, Suite 800, Austin, TX, 78701, US

(73) Assignee: International Business Machines Corporation, Armonk, NY (US)

(21) Appl. No.: 09/814,397

(22) Filed: Mar. 21, 2001

(51) Int. Cl. G10L 15/26

(52) U.S. Cl. 704/235

(57) ABSTRACT

The aforementioned needs are addressed by the present invention. Accordingly, there is provided, in a first form, a depth cue method. The method includes scanning a depth map corresponding to an image, in response to user input. A nonvisual cue corresponding to a depth value in the depth map is output, for each pixel scanned.

There is also provided, in a second form, a computer program product. The program product includes a program of instructions for performing a scan of a depth map corresponding to an image, in which the scan is performed in response to user input. In response, a nonvisual cue is output corresponding to a depth value in the depth map, for each pixel scanned.

Additionally, there is provided, in a third form, a data processing system. The system includes circuitry operable for scanning a depth map. The depth map is scanned in response to user input. Also included is circuitry operable for outputting a nonvisual cue corresponding to a depth value in the depth map. The novisual cue is output for each pixel scanned.

### CROSS REFERENCE TO RELATED APPLICATIONS

The present invention is related to the following U.S. Patent Applications which are hereby incorporated herein by reference: Ser. No. 09/______, “Apparatus for Outputting Textual Renditions of Graphical Data and Method Therefor” (Attorney Docket No. AUS9-2001-0095US1); Ser. No. 09/______, “Scanning and Outputting Textual Information in Web Page Images” (Attorney Docket No. AUS9-2001-0096US1); and Ser. No. 09/______, “Extracting Textual Equivalents of Multimedia Content Stored in Multimedia Files” (Attorney Docket No. AUS9-2001-0097US1).

### TECHNICAL FIELD

The present invention relates to the field of assisting individuals with disabilities through technology, and more particularly to providing depth cues in graphical information contained in web pages to promote accessibility to individuals with disabilities.

### BACKGROUND INFORMATION

Congress passed the “Assistive Technology Act of 1998” to promote the assistance of individuals with disabilities through technology such as encouraging the promotion of technology that will allow individuals with disabilities to partake in the information technology, e.g., Internet.

The development of computerized distribution information systems, such as the Internet, allows users to link with servers and networks, and thus retrieve vast amounts of electronic information that was previously unavailable using conventional electronic mediums. Such electronic information increasingly is replacing the more conventional means of information distribution such as newspapers, magazines and television.

Users may be linked to the Internet through a hypertext system of servers commonly referred to as the World Wide Web (WWW). With the World Wide Web, an entity having a domain name may create a “web page” or “page” that can provide information and, to some degree, some interactivity. Referring to FIG. 1, systematically illustrating network system 100. Web server 102 may store web pages for transmission to a web client 104, via Internet 106.

A computer user may “browse”, i.e., navigate around, the WWW by utilizing a suitable web browser, e.g., Netscape Navigator™, Internet Exploder™, or a talking browser such as, Home Page Reader™ (HPR) available from International Business Machines Corporation, and a network gateway, e.g., Internet Service Provider (ISP). A web browser allows the user to specify or search for a web page on the WWW and subsequently retrieve and display web pages on the user's computer screen. Such web browsers are typically installed on personal computers or workstations to provide web client services, such as web client 104, but increasingly may be found on wireless devices such as cell phones.

The Internet is based upon a suite of communication protocols known as Transmission Control Protocol/Internet Protocol (TCP/IP) which sends packets of data between a host machine, e.g., server computer on the Internet commonly referred to as a web server, and a client machine, e.g., a user's computer connected to the Internet. The WWW is a network of computers that use an Internet interface protocol which is supported by the same TCP/IP transmission protocol.

A web page may typically include content in a multiplicity of media. In addition to text, these may include images, audio and video. Examples of images may include charts and graphs. Images audio and video may be specified in a HyperText Markup Language (HTML) file that is sent from the web server, such as web server 102, to the client machine, such as web client 104. HTML files may be exchanged on the Internet in accordance with the HyperText Transfer Protocol (HTTP). In the HTML source code, images, video and audio may be specified in various files of different formats. For example, an image may be represented in a Graphics Interchange Format (GIF), Joint Photographic Experts Group (JPEG) and Portable Network Graphics (PNG) file format. Video may be represented in a Moving Pictures Expert Group (MPEG) file format. Audio maybe represented in a MPEG Audio Layer 3 (MP3) file format. The HTML file may then be parsed by the web browser in order to display the images and graphics on the client machine.

Images in a web page are inaccessible to the visually impaired user. Consequently, there is a need in the art, generally, to improve the accessibility of this information to such users. In particular, there is a need in the art to convey to the visually impaired user depth cues contained in the images in a web page.

### SUMMARY OF THE INVENTION

The aforementioned needs are addressed by the present invention. Accordingly, there is provided, in a first form, a depth cue method. The method includes scanning a depth map corresponding to an image, in response to user input. A nonvisual cue corresponding to a depth value in the depth map is output, for each pixel scanned.

There is also provided, in a second form, a computer program product. The program product includes a program of instructions for performing a scan of a depth map corresponding to an image, in which the scan is performed in response to user input. In response, a nonvisual cue is output corresponding to a depth value in the depth map, for each pixel scanned.

Additionally, there is provided, in a third form, a data processing system. The system includes circuitry operable for scanning a depth map. The depth map is scanned in response to user input. Also included is circuitry operable for outputting a nonvisual cue corresponding to a depth value in the depth map. The novisual cue is output for each pixel scanned.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a network system which may be used with the present invention;

FIG. 2 illustrates, in block diagram form, a data processing system implemented in accordance with the present invention;

FIG. 3 illustrates, in flow chart form, an image depth representation methodology in accordance with an embodiment of the present invention;

FIGS. 3.1-3.3 schematically illustrate an image and corresponding pixel intensity and depth maps in conjunction with the embodiment of the present invention in FIG. 3; and

FIG. 4 illustrates, in flow chart form a depth map generation methodology which may be used with the embodiment in FIG. 2.

### DETAILED DESCRIPTION

The present invention provides a system and method for providing depth cues drawn from images appearing in a web page. The depth cues may be output in a format accessible to those users with visual impairments. For example, the depth cues may be output in an audio form. Alternatively, a tactile format may be used. The depth information may be incorporated in the web page itself, via, for example, an “ALT” tag. Additionally, the depth information may be generated from the images themselves.

In the following description, numerous specific details are set forth to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted in as much as such details are not necessary to obtain a complete understanding of the present invention and are within the skills of persons of ordinary skill in the relevant art.

Refer now to the drawings wherein depicted elements are not necessarily shown to scale and wherein like or similar elements are designated by the same reference numeral through the several views.

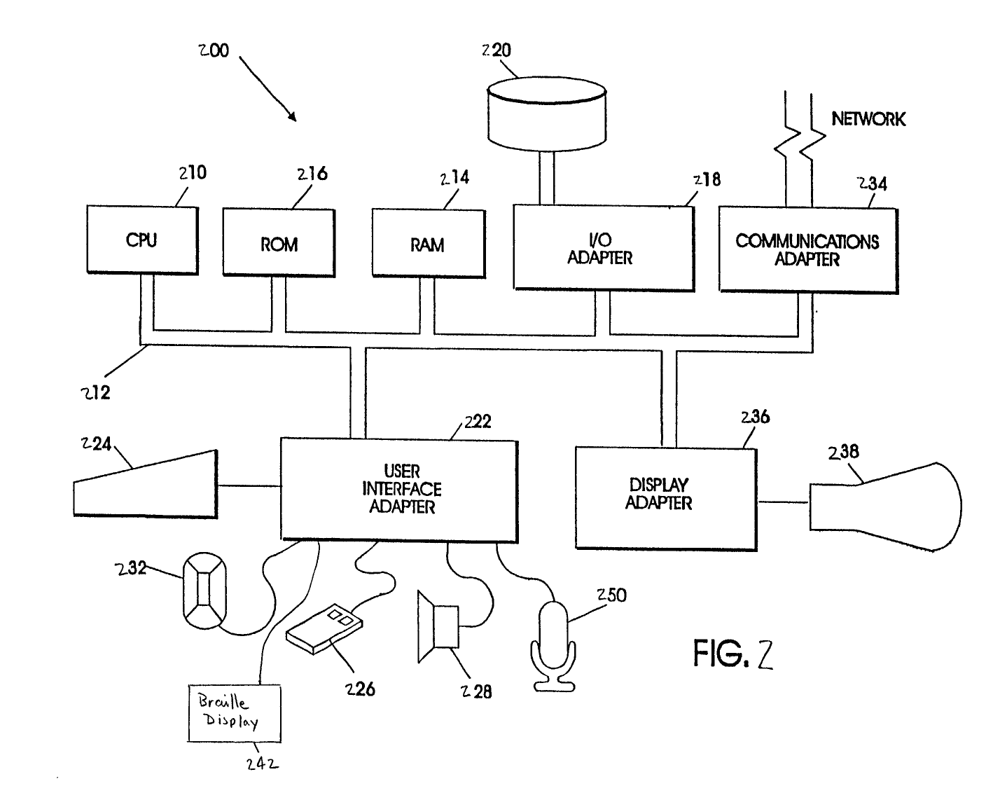

Referring first to FIG. 2, an example is shown of a data processing system 200 which may be used for the invention. The system has a central processing unit (CPU) 210, which is coupled to various other components by system bus 212. Read only memory (“ROM”) 216 is coupled to the system bus 212 and includes a basic input/output system (“BIOS”) that controls certain basic functions of the data processing system 200. Random access memory (“RAM”) 214, I/O adapter 218, and communications adapter 234 are also coupled to the system bus 212. I/O adapter 218 may be a small computer system interface (“SCSI”) adapter that communicates with a disk storage device 220. Communications adapter 234 interconnects bus 212 with an outside network enabling the data processing system to communicate with other such systems. Input/Output devices are also connected to system bus 212 via user interface adapter 222 and display adapter 236. Keyboard 224, track ball 232, mouse 226, speaker 228, microphone 250 and tactile display 242 are all interconnected to bus 212 via user interface adapter 222. Display monitor 238 is connected to system bus 212 by display adapter 236. In this manner, a user is capable of inputting to the system throughout the keyboard 224, trackball 232 or mouse 226 and receiving output from the system via speaker 228, display 238 and tactile display 242.

Preferred implementations of the invention include implementations as a computer system programmed to execute the method or methods described herein, and as a computer program product. According to the computer system implementation, sets of instructions for executing the method or methods are resident in the random access memory 214 of one or more computer systems configured generally as described above. Until required by the computer system, the set of instructions may be stored as a computer program product in another computer memory, for example, in disk drive 220 (which may include a removable memory such as an optical disk or floppy disk for eventual use in the disk drive 220). Further, the computer program product can also be stored at another computer and transmitted when desired to the user's work station by a network or by an external network such as the Internet. One skilled in the art would appreciate that the physical storage of the sets of instructions physically changes the medium upon which it is stored so that the medium carries computer readable information. The change maybe electrical, magnetic, chemical, biological, or some other physical change. While it is convenient to describe the invention in terms of instructions, symbols, characters, or the like, the reader should remember that all of these and similar terms should be associated with the appropriate physical elements.

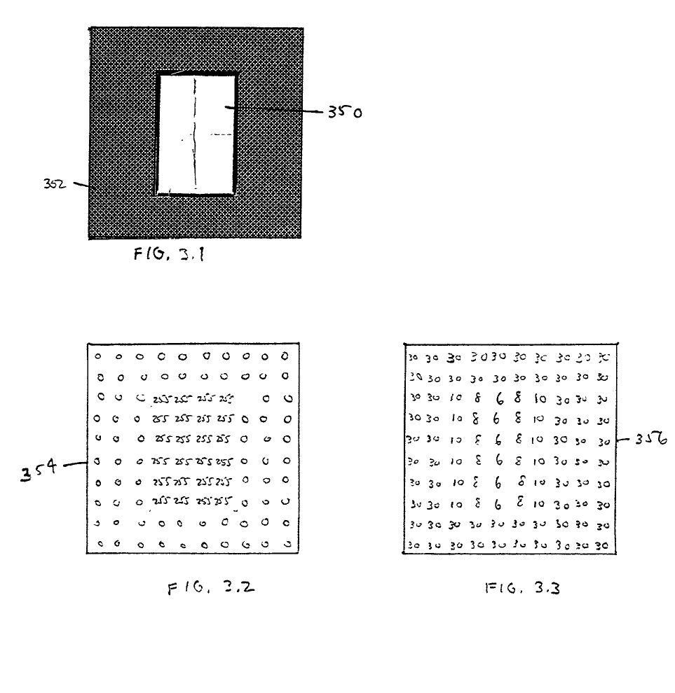

Refer now to FIG. 3 illustrating, in flow chart form, image depth representation methodology 300 in accordance with the principles of the present invention. In step 302 a web page is received. In step 304 images incorporated in the web page are extracted. That is, in step 304 the image information is identified, and the associated image files are retrieved for further processing in accordance with the principles discussed hereinbelow. As would be recognized by persons of ordinary skill in the data processing art, an image file may be represented in a multiplicity of formats, for example, in a GIF, JPEG, or PNG file format, for example. Additionally, a sequence of images operable for displaying motion, such as images forming a “motion picture,” which may be represented in an MPEG file format.

In step 306, it is determined if a depth map is associated with an image in the web page.

(A depth map may be associated with an image in the HTML of the web page by the following exemplary code snippet:

<HTML>

<IMG SRC=“cyl_img.gif” LONGDESC=cyl_ingdepth.txt>

</HTML>

where, the image file, in GIF format, is called cyl_img.gif and the associated depth map is called cyl_imgdepthmap.txt. An artisan of ordinary skill would appreciate that the file names are illustrative, and that the code snippet is exemplary, and other coding may be used to associate a depth image with an image in a web page, and would fall within the spirit and scope of the present invention. A depth map is a data structure, for example, a two-dimensional array, in which each member thereof corresponds to a pixel in the image associated with the depth map. (Note that a depth map may be associated with the image by use of an HTML “ALT” tag.) Each element of the data structure, such as a two-dimensional array, has a value in a predetermined range, in which the value represents a depth of the image element represented by the corresponding pixel. (R. Dutta and C. C. Weems, Parallel Dense Depth from Motion on the Image Understanding Architecture; 1993 IEEE COMPUTER SOCIETY CONFERENCE ON COMPUTER VISION AND PATTERN RECOGNITION 154 (1993), which is hereby incorporated herein by reference.) FIGS. 3.1-3.3 schematically depict an image and associated intensity and depth maps, for illustrative purposes. FIG. 3.1 illustrates an elevation view image of a “white” cylindrical object 350 against a “black” background 352. (Note that, for ease of illustration, “black” background 352 is rendered as a mottled pattern.) FIG. 3.2 illustrates an intensity pixel map 354, corresponding to the image of FIG. 3.1. In FIG. 3.2 the value “255” represents saturated “white” pixels of cylindrical object 350 and the value “0” represents pixels of the “black” background 352. For the purposes of FIG. 3.2, it is assumed that intensity values are represented by an eight-bit gray scale, however, it would be recognized by artisans of ordinary skill that this is illustrative, and other numbers of bits may be used to represent intensity values. It would be further understood that the one-hundred entries in intensity map 354 is also illustrative, and an image may be represented by other numbers of pixels. FIG. 3.3 illustrates a depth map 356, corresponding to the image of FIG. 3.1. In FIG. 3.3 the value “30” represents pixels of background 352, the portion of the image “furthest” from a viewer, and the value “6” represents pixels of the object 350 that are “nearest” the viewer. Intermediate values, “8” and “10”, represent pixels of object 350 corresponding to portions of the curved cylindrical surface that are receding from the viewer toward background 352. For the purposes of FIG. 3.3, it is assumed that depth values are represented by an five-bit value, however, it would be recognized by artisans of ordinary skill that this is illustrative, and other numbers of bits may be used to represent depth values. It would be further understood that the one-hundred entries in depth map 356 is also illustrative, and an image may be represented by other numbers of pixels. It would be appreciated that depth maps having depth values represented by other numbers of bits and containing other numbers of entries would fall within the spirit and scope of the present invention.

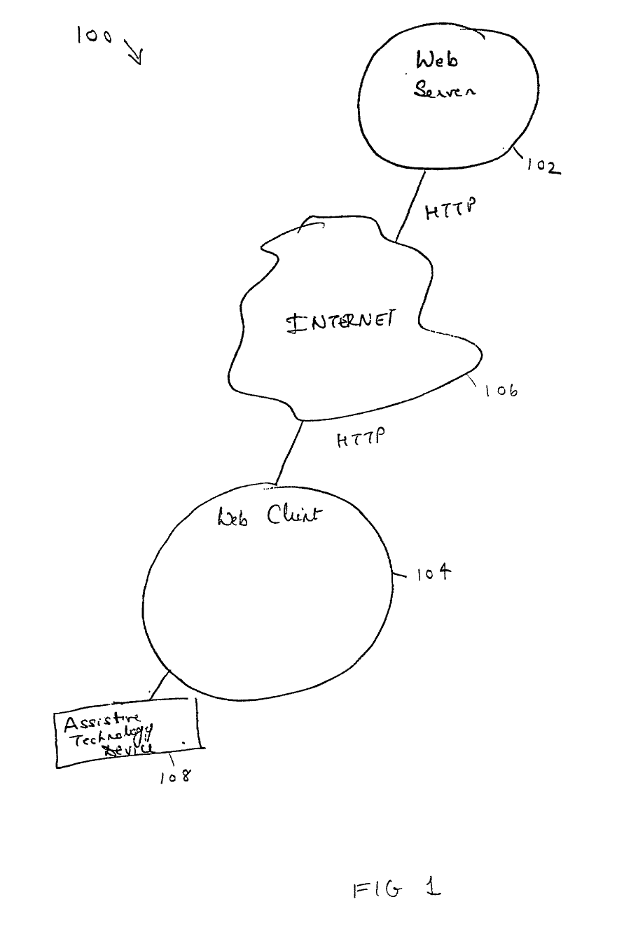

If a depth map corresponding to an image in the web page is associated therewith, in step 205, the depth map is fetched from the web server, such as web server 102, FIG. 1. Methodology 300 proceeds to step 307, and while receiving user input scans the image depth map, step 308 and outputs a representation thereof, step 310. User input maybe in the form, for example, of keystrokes on the keyboard, such as keyboard 124, FIG. 1, in which keyboard arrows are used to scan through the depth map as methodology 300 loops over steps 307, 308 and 310. Thus, in step 308, in response to the user input, a scan through the image depth map is performed. At each pixel, in step 310, a representation of the depth value associated with the pixel is output. The output may be in an audio format, wherein a pitch or tone of the audio signal represents the depth value. For example, a “low” pitch may represent a foreground, or “near” element of the image corresponding to the pixel, and, conversely, a “high” pitch may represent a “distant” element. Gradations in tone between a predetermined lowest pitch (corresponding, for example, to the smallest depth value in the predetermined range) and a predetermined highest pitch (corresponding to the largest depth value) may, thus, represent to the visually impaired user a range of depths from the “foreground” to the “background” of the image. Alternatively, amplitude, rather than pitch may similarly be used to provide depth cues to the visually impaired user. In yet another embodiment, a tactile representation may be used via a tactile display, such as tactile display 142, FIG. 1. In such a display, an array of mechanical elements, for example “pins” or similar elastic members (for example, springs) may be excited with an amplitude corresponding to the depth value as the image depth map is scanned. As used herein, an elastic member is capable of returning to an undeformed state on removal of a deforming stress, and is not meant to be limited to members in which the stress-strain relationship is linear.)

After the user input terminates, methodology 300 breaks out of the loop via the “False” path in step 307, and process 300 terminates, step 318.

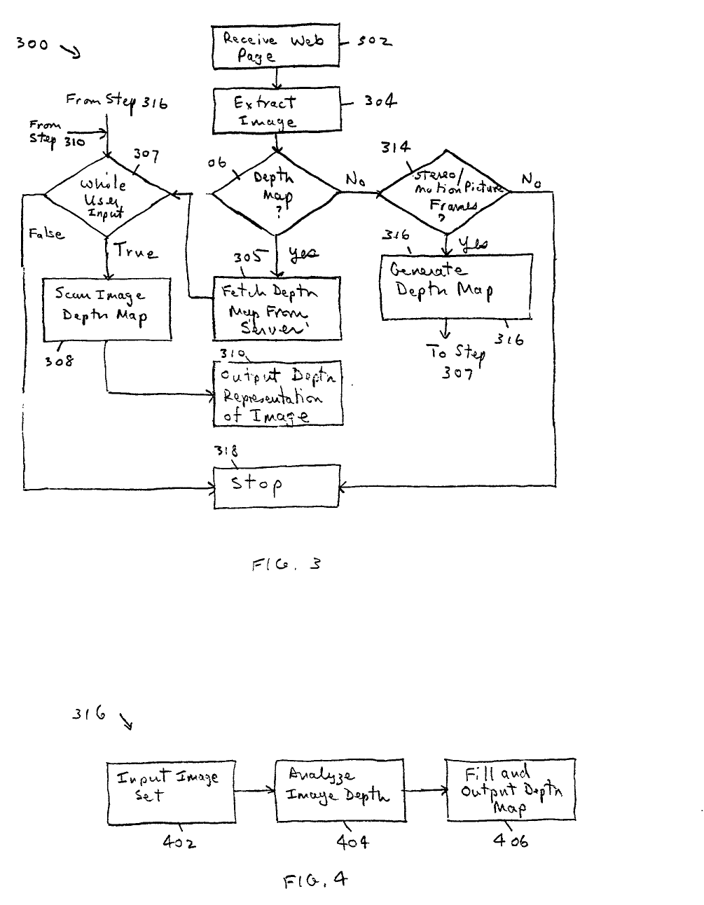

Returning to step 306, if a depth map has not been associated with an image in the web page, methodology 300 determines if image information is available from which a depth map may be generated. In step 314, it is determined if either a stereographic image pair has been provided in the web page, or a motion picture image file is included in the page. If so, in step 316, discussed further hereinbelow in conjunction with FIG. 4, a depth map is generated and process 300 proceeds to step 307 to perform the image depth map scan as previously described. If, however, in step 314, image information from which a depth map may be generated has not been included in the web page, process 300 terminates, step 318.

Referring now to FIG. 4, step 416 of FIG. 3 for generating a depth map is described in additional detail. In step 402, an image set is input. This may, for example, be a sequence of images constituting a portion of a motion picture file. Additionally, the image set maybe a pair of stereographic images. In step 404, the image depth is analyzed, and a depth value assigned to each pixel of the image. Techniques for analyzing depths in an image from stereographic views and motion are described in R. Dutta and C. C. Weems, Parallel Dense Depth from Motion on the Image Understanding Architecture; 1993 IEEE COMPUTER SOCIETY CONFERENCE ON COMPUTER VISION AND PATTERN RECOGNITION 154 (1993), incorporated herein by reference. Alternatively, image depth may be analyzed using commercially available software, for example, KBVision™ from Amerinex Applied Imaging, Inc., Amherst MA, or Khoros Pro™ from Khoral Research, Inc., Albuquerque, N.M., maybe used. In step 406, the depth map is filled by setting the data values in a data structure, such as a two-dimensional array, and the depth map containing the depth values generated in analysis step 404, is output. This depth map may then be scanned in accordance with the principles of methodology 300, FIG. 3, as previously described.

Although the present invention and its advantages have been described in detail, it should be understood that various changes, substitutions and alterations can be made herein without departing from the spirit and scope of the invention as defined by the appended claims.

What is claimed is:

1. A depth cue method comprising the steps of:
scanning a depth map corresponding to an image, in response to user input; and
outputting a nonvisual cue corresponding to a depth value in said depth map, for each pixel scanned.

2. The method of claim 1 wherein said nonvisual cue is selected from the group consisting of auditory cues and tactile cues.

3. The method of claim 1 wherein said depth map is received in response to a web page containing said image.

4. The method of claim 3 further comprising the step of, if no depth map is received in response to said web page containing said image, generating said depth map.

5. The method of claim 4 wherein said step of generating said depth map comprises:
performing a depth analysis of a set of images associated with said image, said set of images operable for extracting depth information therefrom.; and
assigning a depth value corresponding to said depth information for each pixel corresponding to said image.

6. The method of claim 5 wherein said set of images associated with said image is selected from the group consisting of a stereographic pair including said image and a plurality of images operable for displaying motion.

7. The method of claim 5 wherein said step of generating said depth map further comprises the steps of:
setting each depth value in a data structure to form said depth map; and
outputting said data structure.

8. A computer program product embodied in a tangible storage medium, the program product for accessing graphical data, the program product including a program of instructions for performing the steps of:
scanning a depth map corresponding to an image, in response to user input; and
outputting a nonvisual cue corresponding to a depth value in said depth map, for each pixel scanned.

9. The program product of claim 8 wherein said nonvisual cue is selected from the group consisting of auditory cues and tactile cues.

10. The program product of claim 8 wherein said depth map is received in response to a web page containing said image.

11. The program product ofclaim 10 further comprising programming for performing the step of, if no depth map is received in response to said web page containing said image, generating said depth map.

12. The method of claim 11 wherein said programming for performing step of generating said depth map comprises programming for performing the steps of:
performing a depth analysis of a set of images associated with said image, said set of images operable for extracting depth information therefrom.; and
assigning a depth value corresponding to said depth information for each pixel corresponding to said image.

13. The program product of claim 12 wherein said set of images associated with said image is selected from the group consisting of a stereographic pair including said image and a plurality of images operable for displaying motion.

14. The program product of claim 12 wherein said programming for performing step of generating said depth map further comprises programming for performing the steps of:
setting each depth value in a data structure to form said depth map; and
outputting said data structure.

15. A data processing system comprising:
circuitry operable for scanning a depth map corresponding to an image, in response to user input; and
outputting a nonvisual cue corresponding to a depth value in said depth map, for each pixel scanned.

16. The system of claim 15 wherein said nonvisual cue is selected from the group consisting of auditory cues and tactile cues.

17. The system of claim 15 wherein said depth map is received in response to a web page containing said image.

18. The system of claim 17 further comprising circuitry operable for, if no depth map is received in response to said web page containing said image, generating said depth map.

19. The system of claim 18 wherein said circuitry operable for generating said depth map comprises:
circuitry operable for performing a depth analysis of a set of images associated with said image, said set of images operable for extracting depth information therefrom.; and
circuitry operable for assigning a depth value corresponding to said depth information for each pixel corresponding to said image.

20. The system of claim 19 wherein said set of images associated with said image is selected from the group consisting of a stereographic pair including said image and a plurality of images operable for displaying motion.

21. The system of claim 17 wherein said circuitry operable for generating said depth map further comprises:
circuitry operable for setting each depth value in a data structure to form said depth map; and
circuitry operable for outputting said data structure.
